(19) United States
(12) Patent Application Publication
(10) Pub. No.: US 2024/0292488 A1
(43) Pub. Date: Aug. 29, 2024

(54) COMMUNICATION APPARATUS AND TERMINAL APPARATUS

(71) Applicant: SHARP KABUSHIKI KAISHA, Sakai City, Osaka (JP)

(72) Inventors: KATSUTOSHI ISHIKURA, Sakai City, Osaka (JP); Tadashi AOKI, Sakai City, Osaka (JP); ATSUSHI YAMAZAKI, Sakai City, Osaka (JP); HIDEYUKI NAKANISHI, Sakai City, Osaka (JP); SHINICHI SAWADA, Sakai City, Osaka (JP)

(21) Appl. No.: 18/572,998

(22) PCT Filed: Feb. 22, 2022
(86) PCT No.: PCT/JP2022/007060

§ 371 Date: Dec. 21, 2023

(30) Foreign Application Priority Data
Jun. 24, 2021 (JP) 2021-104764

(51) Int. Cl. H04W 76/28; H04L 5/00; H04W 72/512

(52) U.S. Cl. CPC H04W 76/28; H04L 5/001; H04W 72/512

(57) ABSTRACT

There is provided a communication apparatus and a terminal apparatus that can improve low latency operation performance. The communication apparatus includes a control unit that configures a configuration value related to a DRX operation in a terminal apparatus depending on a state of the terminal apparatus that can perform wireless communication by both a first communication scheme and a second communication scheme; and a transmission unit that transmits the configuration value configured by the control unit to a base station apparatus or the terminal apparatus. In a case that the terminal apparatus is in a first state, the control unit configures the configuration value to a first value for the first communication scheme and the second communication scheme in such a manner that the first communication scheme and the second communication scheme come into an active state at temporally different timings, with regard to the DRX operation.

### TECHNICAL FIELD

An aspect of the disclosure relates to a communication apparatus and a terminal apparatus. This application claims priority based on JP 2021-104764 filed in Japan on Jun. 24, 2021, the content of which is incorporated herein.

### BACKGROUND ART

PTL 1 describes a Discontinuous Reception (DRX) operation in Long Term Evolution (LTE). On the other hand, as high-speed wireless communication, a communication scheme of the fifth generation mobile communication system (5G) standard is being put to practical use. In the 5G standard, an ultra-low latency operation, an ultra-high capacity operation, and multiple simultaneous connectivity are expected.

### CITATION LIST

### Patent Literature

PTL 1: JP 2019-68468 A

### SUMMARY

### Technical Problem

The DRX operation may also be applied to the communication scheme of the 5G standard. However, PTL 1 does not disclose a DRX configuration method in which features such as the ultra-low latency operation in the 5G standard are taken into account.

An embodiment of the disclosure provides a communication apparatus and a terminal apparatus that can improve low latency operation performance.

### Solution to Problem

A communication apparatus according to an embodiment of the disclosure includes a control unit that configures a configuration value related to a DRX operation in a terminal apparatus depending on a state of the terminal apparatus that can perform wireless communication by both a first communication scheme and a second communication scheme; and a transmission unit that transmits the configuration value configured by the control unit to a base station apparatus or the terminal apparatus. In a case that the terminal apparatus is in a first state, the control unit configures the configuration value to a first value for the first communication scheme and the second communication scheme in such a manner that the first communication scheme and the second communication scheme come into an active state at temporally different timings, with regard to the DRX operation.

A terminal apparatus according to an embodiment of the disclosure includes a first communication unit that can perform wireless communication by a first communication scheme; a second communication unit that can perform wireless communication by a second communication scheme; and a control unit that performs a DRX operation in a first mode and a second mode. The control unit brings the first communication unit and the second communication unit into an active state at temporally different timings in the first mode, with regard to the DRX operation.

### BRIEF DESCRIPTION OF DRAWINGS

FIG. 1 is a conceptual diagram of a communication system according to a first embodiment.

FIG. 2 is a timing chart illustrating a concept of a C-DRX operation according to the first embodiment.

FIG. 3 is a conceptual diagram of C-DRX configuration data according to the first embodiment.

FIG. 4 is a flowchart illustrating an operation of a base station apparatus according to the first embodiment.

FIG. 5 is a timing chart illustrating a concept of a relationship between the C-DRX operation and power consumption according to the first embodiment.

FIG. 6A is a block diagram illustrating an LTE base station apparatus according to a second embodiment.

FIG. 6B is a block diagram illustrating an NR base station apparatus according to the second embodiment.

FIG. 7 is a block diagram of a terminal apparatus according to the second embodiment.

FIG. 8 is a flowchart illustrating a C-DRX configuration method according to the second embodiment.

FIG. 9A is a flowchart illustrating an operation of a communication system according to the second embodiment.

FIG. 9B is a flowchart illustrating an operation of a communication system according to a modification of the second embodiment.

FIG. 10 is a timing chart illustrating a concept of a relationship between a C-DRX operation and power consumption according to the second embodiment.

FIG. 11 is a conceptual diagram of a communication system according to a third embodiment.

FIG. 12 is a timing chart illustrating a concept of a C-DRX operation according to the third embodiment.

FIG. 13 is a flowchart illustrating an operation of a base station apparatus according to the third embodiment.

FIG. 14 is a flowchart illustrating a C-DRX configuration method according to a fourth embodiment.

FIG. 15 is a flowchart illustrating a C-DRX configuration method according to a modification of the fourth embodiment.

FIG. 16A is a flowchart illustrating an operation of a communication system according to the fourth embodiment.

FIG. 16B is a flowchart illustrating an operation of a communication system according to a modification of the fourth embodiment.

FIG. 17 is a block diagram of a core network apparatus according to a fifth embodiment.

FIG. 18 is a block diagram of an MME according to the fifth embodiment.

FIG. 19 is a block diagram of a core network apparatus according to a sixth embodiment.

FIG. 20 is a block diagram of an AMF according to the sixth embodiment.

FIG. 21 is a timing chart illustrating a concept of a C-DRX operation according to a first modification of the third and fourth embodiments.

FIG. 22 is a timing chart illustrating a concept of a C-DRX operation according to a second modification of the third and fourth embodiments.

FIG. 23 is a block diagram of a core network apparatus according to a modification of the third and fourth embodiments.

### DESCRIPTION OF EMBODIMENTS

Embodiments of the disclosure will be described below with reference to the drawings. In the drawings, the same or equivalent elements are denoted by the same reference numerals and duplicate description will be omitted.

### First Embodiment

A communication apparatus and a terminal apparatus according to a first embodiment of the disclosure will be described. The present embodiment relates to a 5G network having a Non-Standalone (NSA) configuration, and communication is performed by simultaneous connection (DC: Dual Connectivity) for both LTE and New Radio (NR). The present embodiment relates to a Continuous-DRX (C-DRX) operation in which the DRX operation occurs for both LTE and NR in such a 5G network having the NSA configuration. In the present embodiment, in particular, a method for configuring the C-DRX operation in a base station apparatus will be described. Note that the “communication apparatus” in the present specification includes a core network apparatus and a base station apparatus.

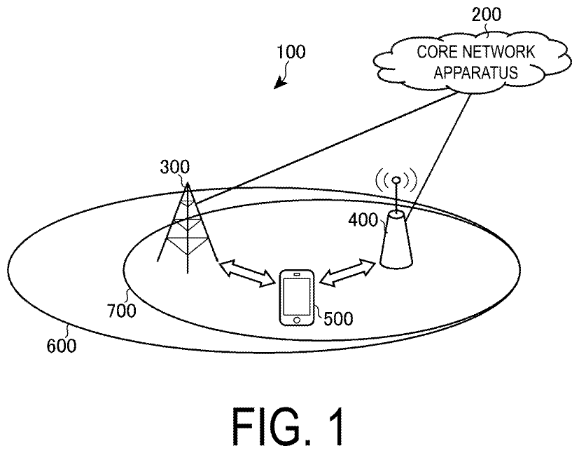

FIG. 1 is a conceptual diagram of a communication system according to the present embodiment. As illustrated, a communication system 100 includes a core network apparatus 200, an LTE base station apparatus 300, an NR base station apparatus 400, and a terminal apparatus 500.

The LTE base station apparatus 300 performs communication by LTE with the terminal apparatus 500 in a cell 600 with which the LTE base station apparatus 300 can communicate. The LTE base station apparatus 300 can transmit information on the LTE base station apparatus 300 and the like to the terminal apparatus 500.

The NR base station apparatus 400 performs communication by NR with the terminal apparatus 500 in a cell 700 with which the NR base station apparatus 400 can communicate. The NR base station apparatus 400 can transmit information on the NR base station apparatus 400 and the like to the terminal apparatus 500. Note that NR is an example of a first communication scheme, and LTE is an example of a second communication scheme.

The terminal apparatus 500 is a terminal apparatus that can perform communication by LTE and NR. The terminal apparatus 500 is, for example, a communication terminal such as a smartphone, a tablet PC, or laptop PC. The terminal apparatus 500 is connected to both the LTE base station apparatus 300 and the NR base station apparatus 400 in the cell 700, uses NR and LTE for user plane processing, and uses LTE for control plane processing. On the other hand, in a case that the terminal apparatus 500 is located in the cell 600 outside the cell 700, the terminal apparatus 500 uses LTE for both the user plane and the control plane. As described above, a 5G network configuration also using a fourth generation mobile communication system (4G) network is NSA.

The core network apparatus 200 is a backbone network and is, for example, a network that controls a mobile network. The core network apparatus 200 is connected to the LTE base station apparatus 300 and the NR base station apparatus 400 and can communicate with each other. The core network apparatus 200 according to the present embodiment corresponds to an NSA compatible Evolved Packet Core (EPC).

In the communication system 100 having the configuration described above, the base station apparatuses 300 and 400 according to the present embodiment perform processing related to DRX configuration. That is, the terminal apparatus 500 can take one of an idle state (RRC_IDLE state) and a connected state (RRC_CONNECTED state). In the connected state, radio resources are allocated to the terminal apparatus 500, and the terminal apparatus 500 is in a communicable state with the base station apparatus 300 and/or 400. In other words, this is a state in which a Radio Resource Control Connection (RRC connection) is established between the terminal apparatus 500 and the base station apparatus 300 and/or 400. The idle state is a state in which the RRC connection is not established and communication of the terminal apparatus 500 is disabled. In the idle state, power consumption can be suppressed lower than that in the connected state. Accordingly, in a case that there is no communication between the terminal apparatus 500 and the base station apparatus 300 and/or 400 for a certain period of time, it is desirable to be in the idle state. However, in the idle state, it takes time to return to the connected state, which makes it difficult to perform a low latency operation. In the present embodiment, in a case that a communication amount decreases in the connected state, for both LTE and NR, a discontinuous reception (DRX) operation is performed while maintaining the connected state. This is called a C-DRX operation. The base station apparatuses 300 and 400 control an operation of the terminal apparatus 500 related to the C-DRX operation.

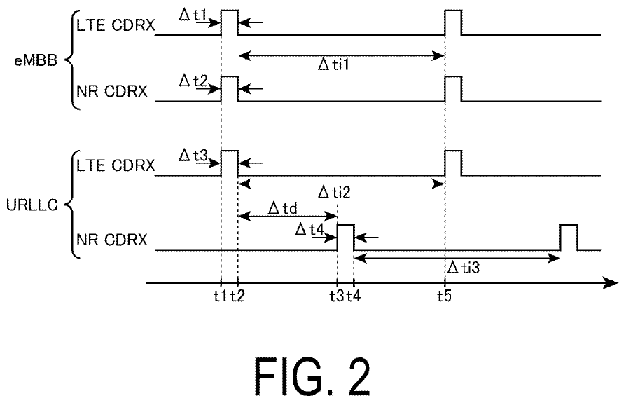

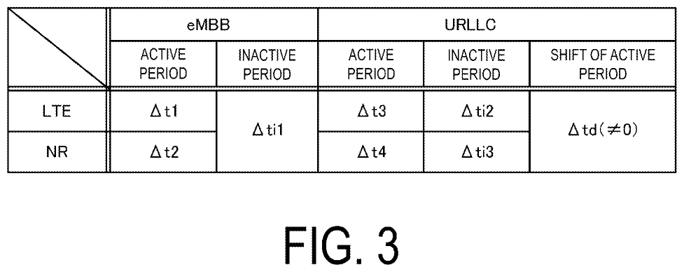

The base station apparatuses 300 and 400 hold DRX configuration data depending on performance required for the terminal apparatus 500. The DRX configuration data will be described below with reference to FIG. 2 and FIG. 3. Note that the performance required for the terminal apparatus 500 according to the present embodiment is either ultra-high capacity (eMBB: Enhanced Mobile Broadband) or ultra-low latency (URLLC: Ultra-Reliable & Low Latency Communications). Note that URLLC, eMBB, and mMTC described below are usage scenarios for NR and 5GC defined in, for example, 3rd Generation Partnership Project (3GPP) Release 15 or the like.

That is, each of the base station apparatuses 300 and 400 according to the present embodiment include a control unit that configures a configuration value related to the discontinuous reception (DRX) operation in a first terminal apparatus 500, for example, a terminal apparatus 500 for URLLC, and a second terminal apparatus 500, for example, a terminal apparatus for eMBB, that can perform wireless communication by both the first communication scheme NR and the second communication scheme LTE; and a transmission unit that transmits the configuration value configured by the control unit to the first terminal apparatus and the second terminal apparatus. With regard to the DRX operation of the first terminal apparatus, for example, the terminal apparatus 500 for URLLC, the control unit configures the configuration value for the first communication scheme NR and the second communication scheme LTE in such a manner that the first communication scheme NR and the second communication scheme LTE come into an active state in a predetermined cycle and at temporally different timings, for example. On the other hand, with regard to the DRX operation of the second terminal apparatus, for example, the terminal apparatus for eMBB, the control unit configures the configuration value for the first communication scheme NR and the second communication scheme LTE in such a manner that the first communication scheme NR and the second communication scheme LTE come into the active state in a predetermined cycle and temporally in parallel, for example.

FIG. 2 is a timing chart illustrating an example of the DRX configuration by the base station apparatuses 300 and 400. In the figure, “LTE CDRX” indicates a state of the DRX operation of LTE, “NR CDRX” indicates a state of the DRX operation of NR, and an “H” level and an “L” level in the timing chart indicate an active state (receivable state) and an inactive state (unreceivable state), respectively. As illustrated, the C-DRX operation is configured for the terminal apparatus 500 for eMBB to establish the active state for LTE and NR in parallel. More specifically, in the example of FIG. 2, the C-DRX operation is configured in such a manner that the active state is established for both LTE and NR at the same timing and in the same period, for example. On the other hand, for the terminal apparatus 500 for URLLC, the C-DRX operation is configured in such a manner that the active state is established for LTE and NR at temporally different timings. More specifically, in the example of FIG. 2, the C-DRX operation is configured in such a manner that the active state is established for LTE and NR temporally alternately.

Data (configuration value) for the DRX configuration as illustrated in FIG. 2 is the DRX configuration data held in the base station apparatus 300 and/or 400. FIG. 3 is a diagram showing an example of the DRX configuration data. As shown, the DRX configuration data holds lengths Δt1 and Δt2 of the active periods and a length Δti1 of the inactive periods of LTE and NR for the terminal apparatus 500 for eMBB during the C-DRX operation. In the present example, Δt1 and Δt2 have the same length, and thus the lengths of the inactive periods of LTE and NR are the same Δti1. However, in a case that Δt1 and Δt2 are different from each other, respective inactive periods may be held for LTE and NR.

In addition, the DRX configuration data holds lengths Δt3 and Δt4 of the active periods and lengths Δti2 and Δti3 of the inactive periods of LTE and NR for the terminal apparatus 500 for URLLC during the C-DRX operation. The DRX configuration data also holds a shift amount Δtd (not 0) between the active periods of LTE and NR. In the present example, for example, Δt3 is equal to Δt4, and Δti2 is equal to Δti3, but there may be allowed a case that Δt3 is not equal to Δt4 and/or Δti2 is not equal to Δti3. In the example of FIG. 2, with regard to the DRX operation of the first terminal apparatus, for example, the terminal apparatus 500 for URLLC, the configuration value is configured in such a manner that the terminal apparatus 500 is deactivated for the second communication scheme LTE during a period for which the terminal apparatus 500 is activated for the first communication scheme NR and is deactivated for the first communication scheme NR during a period in which the terminal apparatus 500 is activated for the second communication scheme LTE.

Note that there can be various methods for configuring the DRX configuration data in the base station apparatuses 300 and 400. For example, the LTE base station apparatus 300 may determine the DRX configuration data illustrated in FIG. 2 and FIG. 3 and notify the NR base station apparatus 400 of the DRX configuration data (data for NR) via an X2 interface, for example. Specifically, for example, the LTE base station apparatus 300 holds the data shown in FIG. 3, and the NR base station apparatus 400 receives Δt2 and Δti1 for eMBB and Δt4, Δti3, and Δtd for URLLC in FIG. 3 from the LTE base station apparatus 300.

As another method, the DRX configuration data may be configured in advance for both the base station apparatuses 300 and 400. In this case, for example, the LTE base station apparatus 300 may hold the LTE-related DRX configuration data for eMBB and for URLLC (data for LTE), and the NR base station apparatus 400 may hold the DRX configuration data (data for NR) whose active timing is shifted from that of the DRX configuration data held by the LTE base station apparatus 300 for URLLC as illustrated in FIG. 2. Specifically, for example, the LTE base station apparatus 300 holds pieces of the data for LTE Δt1, Δti1, Δt3, and Δti2 in FIG. 3, and the NR base station apparatus 400 holds pieces of the data for NR Δt2, Δti1, Δt4, Δti3, and Δtd in FIG. 3. Note that in a case that the active period and the inactive period are the same between LTE and NR, the NR base station apparatus 400 may hold only the data Δtd. In the example of FIG. 3, only one type of configuration value related to LTE and NR is prepared for both eMBB and URLLC, but a plurality of configuration values may be prepared. For example, a plurality of active periods may be prepared for LTE and/or NR, and a plurality of shifts of the active periods may be prepared. In this case, the base station apparatuses 300 and 400 select any one of the plurality of configuration values.

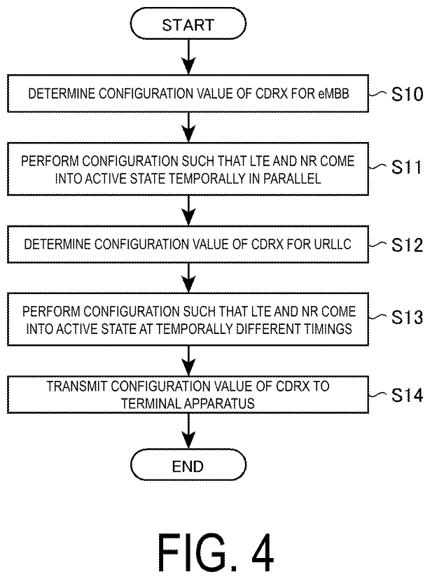

FIG. 4 is a flowchart illustrating the operation of the base station apparatus 300 and/or 400 having the above configuration. As illustrated, the base station apparatus 300 and/or 400 determines the configuration value of the C-DRX operation of the terminal apparatus 500 for eMBB, based on the DRX configuration data (step S10). At this time, as described with reference to FIG. 2 and FIG. 3, the base station apparatus 300 and/or 400 perform configuration in such a manner that LTE and NR come into the active state temporally in parallel (step S11).

Furthermore, the base station apparatus 300 and/or 400 determines the configuration value of the C-DRX operation of the terminal apparatus 500 for URLCC, based on the DRX configuration data (step S12). At this time, as described with reference to FIG. 2 and FIG. 3, the base station apparatus 300 and/or 400 performs configuration in such a manner that LTE and NR come into the active state at temporally different timings (step S13).

Thereafter, the base station apparatuses 300 and 400 transmit information on the C-DRX operations of LTE and NR configured in steps S10 to S13 (that is, the data shown in FIG. 3) to the terminal apparatus 500 (step S14). Note that processing operations of steps S10 and S11 and processing operations of steps S12 and S13 may be performed in a reverse order of FIG. 4 or may be performed in parallel. Alternatively, as described above, the LTE base station apparatus 300 may perform the processing operations of steps S10 to S13 and transmit the configuration value for NR to the NR base station apparatus 400.

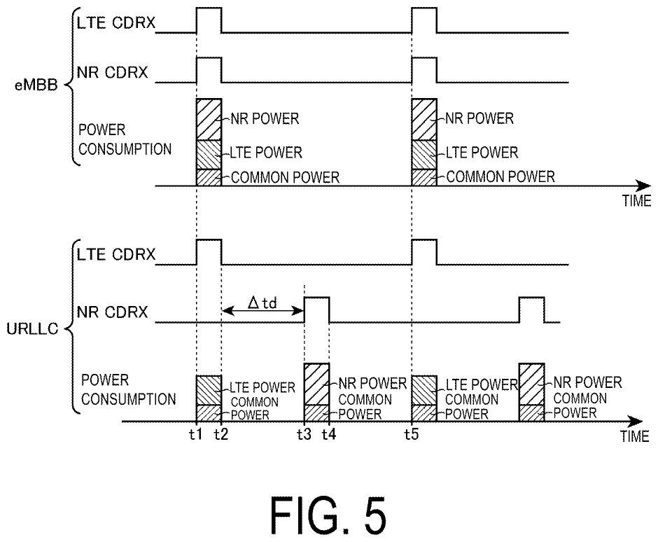

According to the present embodiment, by configuring conditions of the C-DRX operation as described above, it is possible to reduce a delay amount in communication (URLLC) in which the ultra-low latency operation needs to be achieved and to reduce power consumption in large-capacity communication (eMBB). This state is illustrated in FIG. 5. FIG. 5 is a diagram illustrating a magnitude of power consumption of the terminal apparatus 500 in a case that the active state is established for LTE and NR in FIG. 2 described above.

As illustrated, first, in eMBB, low latency is not required as much as in URLLC, and thus the active periods of LTE and NR during the C-DRX operation are configured to the same timing. This makes it possible to halve a frequency at which a common power portion is consumed as compared with a case for URLLC, for example, which can reduce power consumption during the C-DRX operation.

In URLLC, the active periods of LTE and NR can be dispersed temporally. As a result, during the C-DRX operation, it is possible to increase the number of receivable times of communication per unit time, which can reduce the delay amount. For example, in the example of FIG. 5, the maximum delay amount for URLLC can be halved as compared with a case for eMBB.

### Second Embodiment

Subsequently, a communication apparatus and a terminal apparatus according to a second embodiment of the disclosure will be described. The present embodiment relates to specific examples of configurations and operations of the base station apparatus and the terminal apparatus in the 5G network having the NSA configuration described in the first embodiment. Only different points from the first embodiment will be described below.

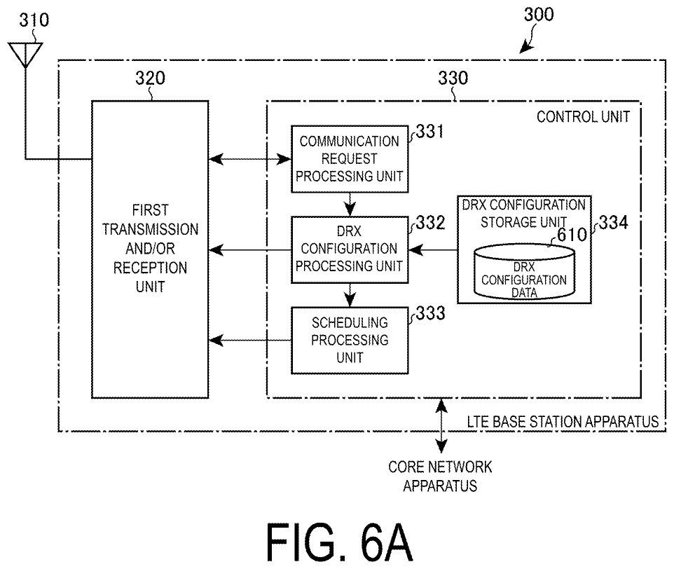

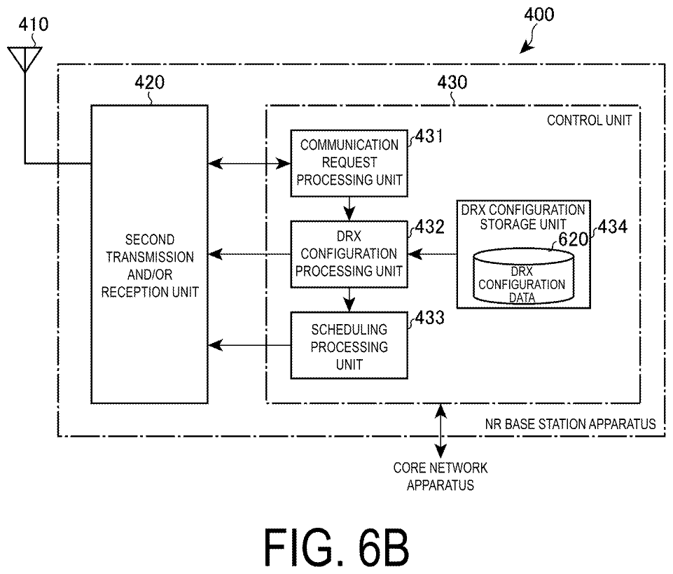

FIG. 6A is a block diagram of an LTE base station apparatus 300 according to the present embodiment. As illustrated, the base station apparatus 300 includes an antenna 310, a first transmission and/or reception unit 320, and a control unit 330. The control unit 330 includes a communication request processing unit 331, a DRX configuration processing unit 332, a scheduling processing unit 333, and a DRX configuration storage unit 334. The communication request processing unit 331, the DRX configuration processing unit 332, and the scheduling processing unit 333 may be a processor such as a CPU, and the DRX configuration storage unit 334 may be a storage apparatus such as a flash memory, a ROM, or a RAM.

The DRX configuration storage unit 334 holds DRX configuration data 610. The DRX configuration data 610 is information for implementing the C-DRX operation described with reference to FIG. 2 in the first embodiment and is, for example, data including information shown in FIG. 3. The DRX configuration data 610 may be configured by a configuration unit (not illustrated) in the control unit 330, for example or may be provided from the outside.

The communication request processing unit 331 receives a communication service request from a terminal apparatus 500 via the antenna 310 and the first transmission and/or reception unit 320. The type of the communication service request received from the terminal apparatus 500 is, for example, a request for ultra-low latency (URLCC) or ultra-high capacity (eMBB) described in the first embodiment. The communication request processing unit 331 interprets the received request and transfers the result to the DRX configuration processing unit 332.

The DRX configuration processing unit 332 reads out the DRX configuration data 610 from the DRX configuration storage unit 334. Then, based on the DRX configuration data 610, the DRX configuration processing unit 332 determines whether the request of the terminal apparatus 500 received from the communication request processing unit 331 can be satisfied. In a case that the request can be satisfied, the communication request processing unit 331 determines a configuration value of the C-DRX operation as described with reference to FIG. 2 and FIG. 3 in the first embodiment, for example, based on the DRX configuration data 610 and transmits the configuration value to the terminal apparatus 500 via the first transmission and/or reception unit 320 and the antenna 310. On the other hand, in a case that the request of the terminal apparatus 500 cannot be satisfied, the communication request processing unit 331 transmits, for example, a predetermined configuration value of the C-DRX operation to the terminal apparatus 500. Note that the determination of the configuration value can be performed by selecting any one of a plurality of configuration values in the DRX configuration data 610, which can satisfy the request of the terminal apparatus 500, for example. The DRX configuration processing unit 332 transfers the determined configuration value of the C-DRX operation to the scheduling processing unit 333.

In a case that data to be transmitted to a terminal apparatus 500 occurs during a period in which the terminal apparatus 500 is in the C-DRX operation, the scheduling processing unit 333 generates a scheduling signal of the data. Then, the scheduling signal is transmitted to the terminal apparatus 500 via the first transmission and/or reception unit 320 and the antenna 310. The terminal apparatus 500 can know a reception timing of the data by receiving the scheduling signal and can efficiently receive the data.

The first transmission and/or reception unit 320 communicates with the terminal apparatus 500 by LTE. For example, the DRX configuration information determined by the DRX configuration processing unit 332 is wirelessly transmitted to the terminal apparatus 500 via the antenna 310. Alternatively, the first transmission and/or reception unit 320 may transmit the DRX configuration data for NR to the NR base station apparatus 400 as described above.

FIG. 6B is a block diagram of the NR base station apparatus 400 according to the present embodiment. As illustrated, the base station apparatus 400 includes an antenna 410, a second transmission and/or reception unit 420, and a control unit 430. The control unit 430 includes a communication request processing unit 431, a DRX configuration processing unit 432, a scheduling processing unit 433, and a DRX configuration storage unit 434. That is, the NR base station apparatus 400 has a configuration similar to that of the LTE base station apparatus 300, and while the LTE base station apparatus 300 performs processing related to LTE communication, the NR base station apparatus 400 performs processing related to NR communication. Accordingly, processing related to the C-DRX configuration is substantially the same as that of the LTE base station apparatus 300 described above.

That is, the DRX configuration storage unit 434 holds DRX configuration data 620. The DRX configuration data 620 is information for implementing the C-DRX operation described with reference to FIG. 2 in the first embodiment and is, for example, data including information shown in FIG. 3. As described in the first embodiment, the DRX configuration data 620 may be provided from the LTE base station apparatus 300, for example. Furthermore, both the DRX configuration data 610 and 620 may hold configuration values related to the C-DRX operations of LTE and NR, or the DRX configuration data 610 may hold a configuration value related to LTE and the DRX configuration data 620 may hold a configuration value related to NR.

The communication request processing unit 431, the DRX configuration processing unit 432, and the scheduling processing unit 433 are the same as the communication request processing unit 331, the DRX configuration processing unit 332, and the scheduling processing unit 333 in the LTE base station apparatus 300, and thus description thereof will be omitted.

The second transmission and/or reception unit 420 communicates with the terminal apparatus 500 by NR. For example, the DRX configuration information determined by the DRX configuration processing unit 432 is wirelessly transmitted to the terminal apparatus 500 via the antenna 410. Alternatively, the second transmission and/or reception unit 420 may receive the DRX configuration data for NR from the LTE base station apparatus 300 as described above.

That is, the base station apparatuses 300 and 400 according to the present embodiment include determination units (for example, DRX configuration processing units 332 and 432) that determine a configuration value related to a discontinuous reception (DRX) operation in the terminal apparatus 500 depending on a state (for example, for URLLC or for eMBB) of the terminal apparatus 500 that can perform wireless communication by both the first communication scheme NR and the second communication scheme LTE, and transmission units 320 and 420 that transmit the configuration value determined by the determination unit to the terminal apparatus 500. In a case that the terminal apparatus 500 is in a first state, for example, for URLLC, the determination unit, for example, the DRX configuration processing unit 332 determines the configuration value to be a first value for the first communication scheme NR and the second communication scheme LTE in such a manner that the first communication scheme NR and the second communication scheme LTE come into the active state in a predetermined cycle and at temporally different timings, with regard to the DRX operation. On the other hand, in a case that the terminal apparatus 500 is in a second state different from the first state, for example, for eMBB, the determination unit determines the configuration value to be a second value different from the first value for the first communication scheme NR and the second communication scheme LTE in such a manner that the first communication scheme NR and the second communication scheme LTE come into the active state in a predetermined cycle and temporally in parallel, with regard to the DRX operation.

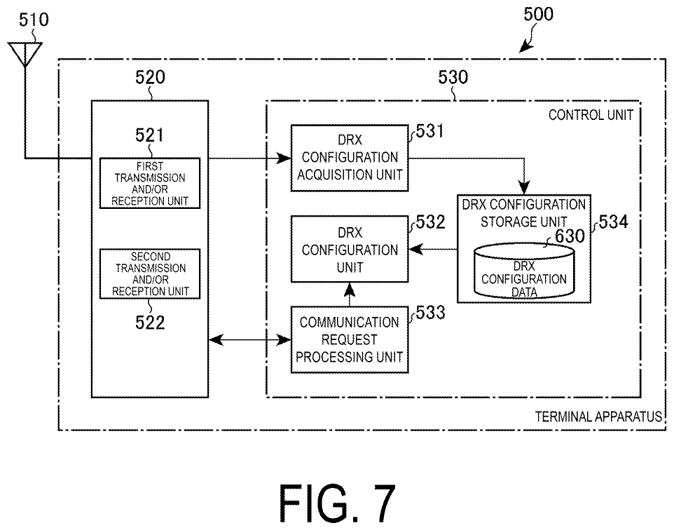

Subsequently, the terminal apparatus 500 will be described below. The terminal apparatus 500 according to the present embodiment is an NSA-compliant terminal and can simultaneously communicate with the LTE base station apparatus 300 and the NR base station apparatus 400. FIG. 7 is a block diagram of the terminal apparatus 500 according to the present embodiment.

As illustrated, the terminal apparatus 500 includes an antenna 510, a communication unit 520, and a control unit 530. The control unit 530 includes a DRX configuration acquisition unit 531, a DRX configuration unit 532, a communication request processing unit 533, and a DRX configuration storage unit 534. The DRX configuration acquisition unit 531, the DRX configuration unit 532, and the communication request processing unit 533 may be a processor such as a CPU, and the DRX configuration storage unit 534 may be a storage apparatus such as a flash memory, a ROM, or a RAM.

The DRX configuration acquisition unit 531 receives pieces of the DRX configuration data 610 and 620 transmitted from the base station apparatuses 300 and 400, respectively, described with reference to FIG. 6A and FIG. 6B via the antenna 510 and the communication unit 520. DRX configuration data 630 is DRX configuration data received from the base station apparatuses 300 and 400, is information for implementing the C-DRX operation described with reference to FIG. 2 in the first embodiment, and is data including information shown in FIG. 3, for example. These are transmitted from the base station apparatuses 300 and 400 described with reference to FIG. 6A and FIG. 6B to the terminal apparatus 500 using, for example, a broadcast channel or a control channel.

The DRX configuration storage unit 534 holds the DRX configuration data 630 acquired by the DRX configuration acquisition unit 531.

The communication request processing unit 533 selects a communication service such as ultra-low latency (URLLC) or ultra-high capacity (eMBB) depending on an application or the like used by the terminal apparatus 500. The communication request processing unit 533 transmits a request for the selected communication service to the base station apparatuses 300 and 400 via the communication unit 520 and the antenna 510. The communication request processing unit 533 also acquires information (for example, URLLC or eMBB) related to a communication service to be configured, which is received from the base station apparatuses 300 and 400 via the antenna 510 and the communication unit 520. Then, the communication request processing unit 533 notifies the DRX configuration unit 532 of the determined communication service.

The DRX configuration unit 532 reads out the configuration value of the C-DRX operation corresponding to the determined communication service from the DRX configuration data 630 held in the DRX configuration storage unit 534. Thereafter, in a case that the C-DRX operation is performed, the DRX configuration unit 532 controls the terminal apparatus 500 based on the read configuration value of the C-DRX operation.

The communication unit 520 includes a first transmission and/or reception unit 521 and a second transmission and/or reception unit 522. The first transmission and/or reception unit 521 communicates with the LTE base station apparatus 300 via the antenna 510 by LTE. The second transmission and/or reception unit 522 communicates with the NR base station apparatus 400 via the antenna 510 by NR. Then, for example, in a case that the C-DRX operation described in the first embodiment is performed, for example, the communication request processing unit 533 or the DRX configuration unit 532 stops the operation of the first transmission and/or reception unit 521 and the second transmission and/or reception unit 522, thereby making LTE and NR inactive. Accordingly, in a case of URLLC, the C-DRX operations for URLLC described with reference to FIG. 2 can be performed by alternately shifting the operation timings of the first transmission and/or reception unit 521 and the second transmission and/or reception unit 522. On the other hand, in a case of eMBB, operations of the first transmission and/or reception unit 521 and the second transmission and/or reception unit 522 are initiated and stopped at the same timing.

That is, the terminal apparatus 500 according to the present embodiment includes a first communication unit 522 that can perform wireless communication by the first communication scheme NR, a second communication unit 521 that can perform wireless communication by the second communication scheme LTE, and the control unit 530 (particularly, for example, the DRX configuration unit 532) that performs the DRX operation in a first mode, for example, for URLLC, and in a second mode, for example, for eMBB. Then, in a case of the first mode, for example, for URLLC, the control unit 530 brings the first communication unit 522 and the second communication unit 521 into the active state with regard to the DRX operation, for example, in a predetermined cycle and at temporally different timings. On the other hand, in a case of the second mode, for example, for eMBB, the control unit 530 brings the first communication unit 522 and the second communication unit 521 into the active state with regard to the DRX operation, for example, in a predetermined cycle and temporally in parallel.

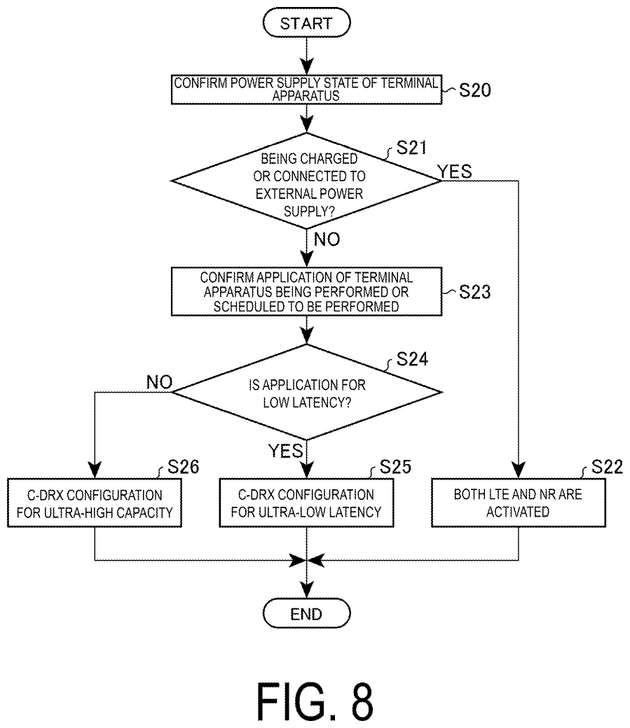

FIG. 8 is a flowchart illustrating an example of a configuration method of the C-DRX operation. In the present example, the configuration of the C-DRX operation can be changed based on a type of the terminal apparatus 500, a power supply connection state of the terminal apparatus 500, and a communication application of the terminal apparatus 500.

As illustrated, for example, the DRX configuration processing units 332 and 432 of the base station apparatuses 300 and 400, respectively, confirm a power supply connection state of the terminal apparatus 500 (step S20). That is, at the time of initiating communication, the terminal apparatus 500 notifies the base station apparatuses 300 and 400 of information on whether a battery is being charged or the terminal apparatus 500 is constantly connected to an external power supply, and the information is held in, for example, the DRX configuration storage units 334 and 434. In a case that the terminal apparatus 500 is being charged or is connected to an external power supply (YES in step S21), the DRX configuration processing units 332 and 432 of the base station apparatuses 300 and 400, respectively, maintain the active state for both LTE and NR (step S22). That is, in this case, the DRX operation is not performed.

Note that steps S20 and S21 may also serve as processing for determining the type of the terminal apparatus 500. In a case that the terminal apparatus 500 is a terminal having a high processing capacity such as a laptop PC, there is a possibility that the terminal apparatus 500 is being charged or is connected to an external power supply in step S21 in many cases. That is, in a case that the terminal apparatus 500 is being charged or is connected to an external power supply, it is determined that the terminal apparatus 500 is a terminal having a high processing capacity. On the other hand, in a case that the terminal apparatus is a terminal whose function is limited to a certain level, such as a smartphone or VR/AR glasses, there is a possibility that the terminal apparatus is not being charged or is not connected to an external power supply in many cases. That is, in a case that the terminal apparatus 500 is not being charged or is not connected to an external power supply, it is determined that the terminal apparatus 500 is a terminal having a limited processing capacity.

In step S21, in a case that the terminal apparatus 500 is not being charged and is not constantly connected to an external power supply (NO in step S21), the DRX configuration processing units 332 and 432 of the base station apparatuses 300 and 400, respectively, confirm a communication application that is being performed or is scheduled to be performed by the terminal apparatus 500 (step S23). For example, in the base station apparatuses 300 and 400, an ID of a communication application and a communication service (for ultra-high capacity, for ultra-low latency, or the like) are associated with each other in advance, and for example, the DRX configuration processing units 332 and 432 of the base station apparatuses 300 and 400, respectively, can recognize the communication application by a method such as receiving the ID of the communication application from the terminal apparatus 500.

In a case that the communication application being performed or scheduled to be performed by the terminal apparatus 500 is for low latency (YES in step S24), that is, in a case that the terminal apparatus 500 is in the first state described above, the DRX configuration processing units 332 and 432 select the C-DRX configuration for ultra-low latency (step S25). That is, the base station apparatus 300 and/or 400 selects the C-DRX configuration for URLLC described with reference to FIG. 2 and transmits DRX configuration data corresponding to the C-DRX configuration for URLLC to the terminal apparatus 500.

On the other hand, in a case that the communication application being performed or scheduled to be performed by the terminal apparatus 500 is not for low latency (NO in step S24), that is, in a case that the terminal apparatus 500 is in the second state described above, the DRX configuration processing units 332 and 432 select the C-DRX configuration for ultra-high capacity (step S26). That is, the base station apparatus 300 and/or 400 selects the C-DRX configuration for eMBB described with reference to FIG. 2, and transmits the DRX configuration data corresponding to the C-DRX configuration for eMBB to the terminal apparatus 500.

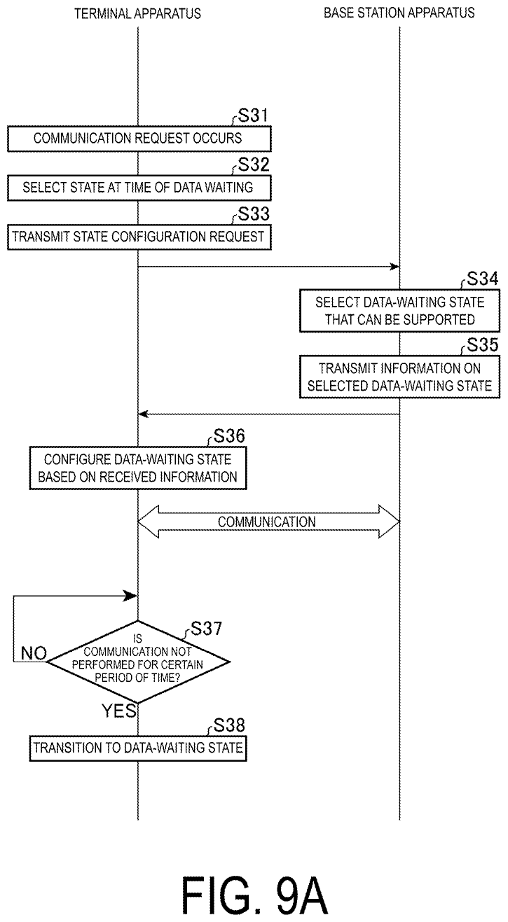

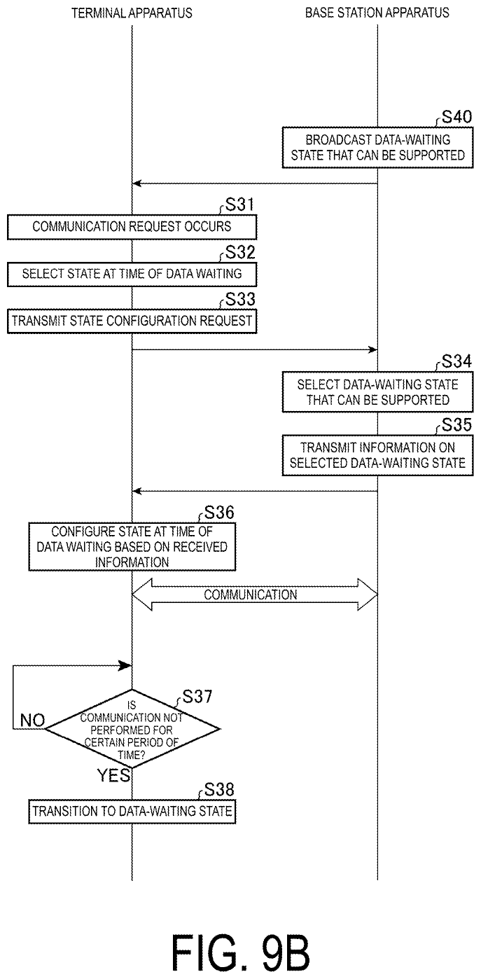

Note that the C-DRX configuration depending on the communication service in steps S23 to S26 in FIG. 8 may be performed in response to a request from the terminal apparatus 500. That is, the terminal apparatus 500 itself may transmit information indicating whether the terminal apparatus 500 operates in the first state (for example, for URLLC) or the second state (for example, for eMBB) to the base station apparatuses 300 and 400. Then, in response to the notification, the base station apparatuses 300 and 400 may indicate to the terminal apparatus 500 whether the terminal apparatus 500 operates in the first mode (for example, for URLLC) or the second mode (for example, for eMBB). Such an example will be described with reference to FIG. 9A. FIG. 9A is a flowchart illustrating a flow of processing in the terminal apparatus 500 and the base station apparatuses 300 and 400.

As illustrated, in a case that a communication request is generated in the terminal apparatus 500 (step S31), the terminal apparatus 500 selects a state at the time of data waiting, that is, a state during a C-DRX operation (step S32). More specifically, at the time of C-DRX operation, either the configuration for eMBB or the configuration for URLLC of the first embodiment described with reference to FIG. 2 is selected. Then, a state configuration request for requesting the configuration selected in step S32 is transmitted to the base station apparatuses 300 and 400 (step S33). As described above, the state configuration request may directly indicate the configuration for eMBB or the configuration for URLLC or may be information (for example, an ID) related to the communication application associated with the configuration. Alternatively, not only the configuration for eMBB or the configuration for URLLC, but also information on the active period, the inactive period, and/or the shift of the active period described with reference to FIG. 3, which is demand by the terminal apparatus 500, may be transmitted. The state configuration request may include a plurality of configurations together with a priority order.

The base station apparatuses 300 and 400 that have received the state configuration request determine whether the request from the terminal apparatus 500 can be supported. Then, in a case that there is a data-waiting state (C-DRX configuration) that can be supported, the state is selected (step S34). In a case that there is no data-waiting state that can be supported, the base station apparatuses 300 and 400 select a predetermined data-waiting state. The base station apparatuses 300 and 400 transmit information on the data-waiting state selected in step S34 to the terminal apparatus 500 as the DRX configuration data 630 (step S35). Then, the terminal apparatus 500 configures a state at the time of data waiting based on the received information (step S36).

Thereafter, communication is performed between the terminal apparatus 500 and the base station apparatuses 300 and 400, and in a case that the communication is stopped for a certain period of time (YES in step S37), the terminal apparatus 500 transitions to a data-waiting state (step S38). At this time, the terminal apparatus 500 waits data in the state configured in step S36. That is, for example, the C-DRX operation is performed by using the configuration for eMBB, the configuration for URLLC, or the like described with reference to FIG. 2.

Note that in the example in FIG. 9A, the base station apparatuses 300 and 400 may notify the terminal apparatus 500 of the data-waiting state that can be supported and the DRX configuration data 630 in advance. A flowchart in such a case is illustrated in FIG. 9B. As illustrated, the base station apparatuses 300 and 400 notify the terminal apparatus 500 of the data-waiting state that can be supported and the DRX configuration data 630 by broadcast information (step S40). More specifically, the notification includes three types of information including the configuration for eMBB and the configuration for URLLC described with reference to FIG. 2 and FIG. 3 of the first embodiment, and the configuration for maintaining the active state for both LTE and NR described in step S22 of FIG. 8 and includes the DRX configuration value described with reference to FIG. 3. Then, in step S32, the terminal apparatus 500 can select the C-DRX configuration in which the base station apparatuses 300 and 400 can support. At this time, in step S35, the base station apparatuses 300 and 400 only need to transmit the type of the data-waiting state that can be supported to the terminal apparatus 500 and do not need to transmit the configuration value of the DRX operation. This is because these configuration values have already been transmitted to the terminal apparatus 500 in step S40. Note that the base station apparatuses 300 and 400 may transmit, in step S40, a data-waiting state (eMBB, URLLC, or always active state) that can be supported and may transmit specific DRX configuration data in step S35.

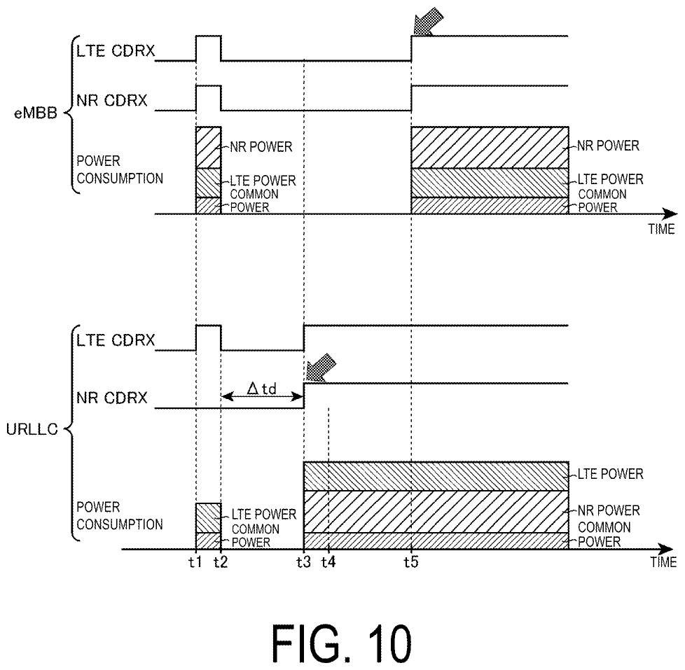

FIG. 10 illustrates a state in which communication occurs during the C-DRX operation, and an arrow in the drawing indicates a timing at which the communication occurs. For example, in the case of the configuration for eMBB, both LTE and NR are in an inactive state until time t5 after being in an active state during a period of time t1 to time t2. Thus, it is difficult to receive communication during this period, and for example, in a case that communication occurs at time t5 at which LTE and NR next come into an active state, the communication can be received. On the other hand, in the case of the configuration for URLLC, NR comes into an active state at time t3. Thus, in a case that communication occurs at time t3, the communication can be received. Then, in the terminal apparatus 500, not only NR but also LTE comes into an active state at time t3, and communication is initiated for both LTE and NR after time t3.

As described above, in the communication system according to the present embodiment, it is possible to perform the optimum C-DRX configuration corresponding to the communication environment, the terminal type, and the communication request (eMBB, URLLC). For example, in a case that an application requiring low latency performance is used in a smartphone or AR glasses while moving, it is possible to reduce battery consumption while maintaining low latency performance. On the other hand, in a case that a 5G-equipped PC or the like is used, there is no need to care about battery consumption, and thus LTE and NR can be activated to maximize the low latency performance of 5G.

### Third Embodiment

Subsequently, a communication apparatus and a terminal apparatus according to a third embodiment of the disclosure will be described. In the present embodiment, the C-DRX configuration method described in the first embodiment is applied to a 5G network having a Standalone (SA) configuration. More specifically, in Carrier Aggregation (CA) using a plurality of component carriers, the same concept as that of the first embodiment is applied to a DRX operation for each component carrier. Only different points from the first embodiment will be described below. In addition, in the present embodiment, a method for configuring a C-DRX operation in a base station apparatus will be described in particular as in the first embodiment.

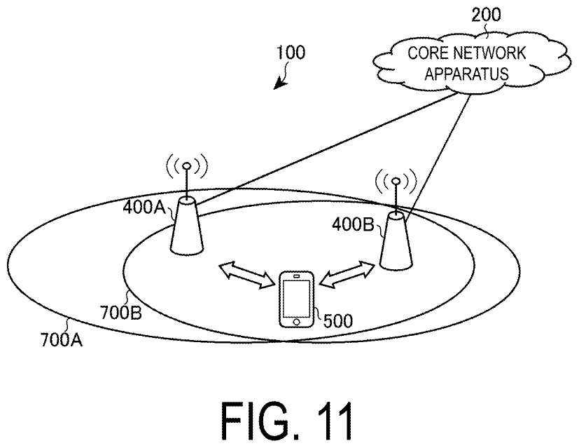

FIG. 11 is a conceptual diagram of a communication system according to the present embodiment. As illustrated, a communication system 100 includes a core network apparatus 200, NR base station apparatuses 400A and 400B, and a terminal apparatus 500.

The NR base station apparatus 400A communicates with the terminal apparatus 500 in a cell 700A in which the NR base station apparatus 400A can communicate by NR. Then, the NR base station apparatus 400A can transmit information on the NR base station apparatus 400A and the like to the terminal apparatus 500. Similarly, the NR base station apparatus 400B communicates with the terminal apparatus 500 in a cell 700B in which the NR base station apparatus 400B can communicate by NR. Then, the NR base station apparatus 400B can transmit information on the NR base station apparatus 400B and the like to the terminal apparatus 500. In 5G, a frequency band of lower than 6 GHz called “Sub-6” and a frequency band of 30 GHz to 300 GHz (28 GHz-band is used in Japan) called “millimeter waves” can be used. In the present embodiment, a case that the NR base station apparatus 400A uses Sub-6 and the NR base station apparatus 400B uses millimeter waves will be described as an example. Note that configurations of the base station apparatuses 400A and 400B are as in FIG. 6B described in the second embodiment.

The terminal apparatus 500 is a terminal apparatus that can communicate by NR. The terminal apparatus 500 is, for example, a communication terminal such as a smartphone, a tablet PC, or laptop PC. Alternatively, the terminal apparatus 500 may be a smart building or a plurality of various sensors or may be electronic equipment that is automatically operated or remotely controlled, and the terminal apparatus 500 is connected to both the NR base station apparatuses 400A and 400B and can communicate therewith. Note that a configuration of the terminal apparatus 500 is obtained by eliminating the first transmission and/or reception unit 521 in FIG. 7 described in the second embodiment.

The core network apparatus 200 is connected to the NR base station apparatuses 400A and 400B and can communicate with each other. The core network apparatus 200 according to the present embodiment is a core network 5GC for 5G (5G Core network).

In the above configuration, the base station apparatuses 400A and 400B according to the present embodiment perform processing related to DRX configuration. In the present embodiment, in addition to the terminal apparatus for which ultra-high capacity (eMBB) is required and the terminal apparatus for which ultra-low latency (URLLC) is required as described in the first embodiment, different DRX configurations are implemented for a terminal apparatus for which both of them (hereinafter, this is referred to as eMBB+URLLC) are required.

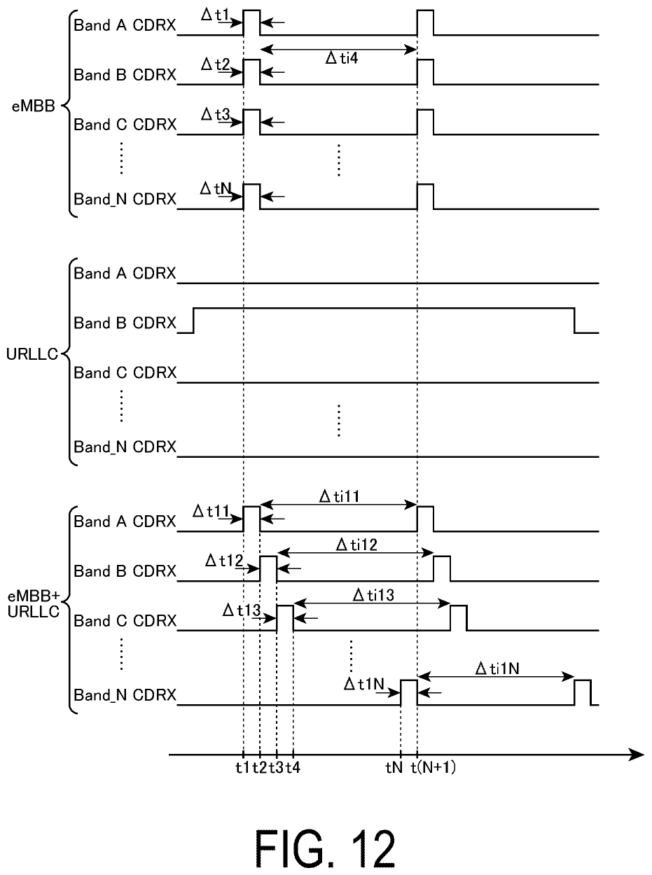

FIG. 12 is a timing chart illustrating an example of the DRX configuration by the base station apparatuses 400A and 400B. In the example of FIG. 12, a case in which carrier aggregation is performed using N (N is a natural number of 2 or more) component carriers is illustrated, and the frequency bands of the corresponding component carriers are referred to as bands A to N. As examples of the bands, bands A to C are Sub-6 frequency bands, and bands D to N are millimeter wave frequency bands.

As illustrated, the C-DRX operation is configured for the terminal apparatus 500 for eMBB in such a manner that the bands A to N come into the active state in parallel. More specifically, in the example of FIG. 12, the C-DRX operation is configured in such a manner that all the bands A to N come into the active state at the same timing and in the same period, for example. For the terminal apparatus 500 for URLLC, the C-DRX operation is configured in such a manner that, for example, one (band B in the example of FIG. 12) of the plurality of bands is always maintained in the active state and the other bands are always in the inactive state. For the terminal apparatus 500 for eMBB+URLLC, the C-DRX operation is configured in such a manner that the plurality of bands A to N come into the active state at temporally different timings as in the first embodiment. Note that in the example of FIG. 12, the C-DRX operation is configured in such a manner that the bands A to N are sequentially brought into the active state, and during the C-DRX operation, at least one of the bands A to N is brought into the active state. That is, for eMBB+URLLC, a second carrier component (for example, band B) comes into the active state at the timing at which a first carrier component (for example, band A) transitions from the active state to the inactive state. Note that, in some cases, the C-DRX configuration for URLLC in FIG. 12 may also be applied to IoT (mMTC: massive Machine Type Communications) using a large number of devices such as meters and sensors. Alternatively, in a case of mMTC and in a case that a sensor that does not need to perform reporting frequently is the terminal apparatus, all the carrier components may be in the inactive state as in an eDRX in the related art.

Data for the DRX configuration as illustrated in FIG. 12 is stored in the DRX configuration storage unit 434 of each of the base station apparatuses 400A and 400B as DRX configuration data 620. The DRX configuration data 620 is obtained by eliminating the data for LTE in FIG. 3 described in the first embodiment. In the present example, the DRX configuration data 620 holds lengths Δt1 to ΔtN of active periods of the bands A to N and a length Δti4 of an inactive period with regard to eMBB, holds information regarding which band is brought into the active state with regard to URLLC, and holds lengths Δt11 to Δt1N of active periods and lengths Δti11 to Δti1N of inactive periods of the bands A to N with regard to eMBB+URLLC. Of course, in a case that there is a shift in the timing of transition to the active state among the bands, Δtd may be held as in the first embodiment.

Also in the present example, Δt1 to ΔtN in eMBB may have the same length or different lengths. The length of Δti4 may also be the same or different among the bands A to N. The same applies to Δt11 to Δt1N and Δti11 to Δti1N in eMBB+URLLC.

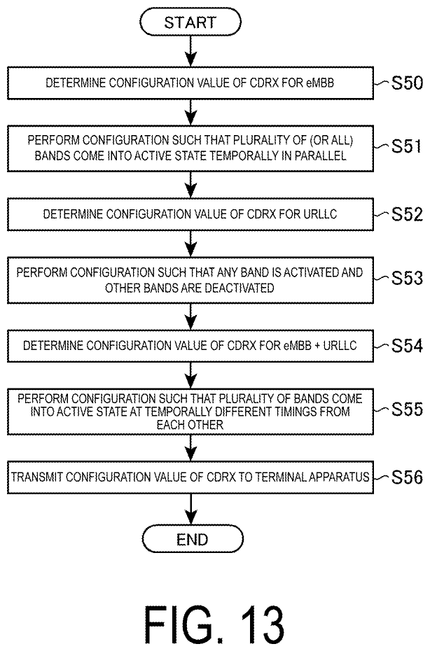

FIG. 13 is a flowchart illustrating an operation of the base station apparatus 400A and/or 400B having the above configuration. As illustrated, the base station apparatus 400A and/or 400B determines a configuration value of the C-DRX operation of the terminal apparatus 500 for eMBB, based on the DRX configuration data 620 (step S50). At this time, as described with reference to FIG. 12, the base station apparatus 400A and/or 400B perform configuration in such a manner that the bands A to N come into the active state temporally in parallel (step S51). Note that in the example of FIG. 12, a case that all the bands A to N come into the active state at the same timing has been described as an example; however, any plurality of bands are brought into the active state, and any of the bands may be brought into the inactive state.

The base station apparatus 400A and/or 400B determines a configuration value of the C-DRX operation of the terminal apparatus 500 for URLLC, based on the DRX configuration data 620 (step S52). At this time, the base station apparatus 400A and/or 400B perform configuration in such a manner that any of the bands A to N is always in the active state and the other bands are in the inactive state as described with reference to FIG. 12 (step S53).

The base station apparatus 400A and/or 400B determines a configuration value of the C-DRX operation of the terminal apparatus 500 for eMBB+URLLC, based on the DRX configuration data 620 (step S54). At this time, as described with reference to FIG. 12, the base station apparatus 400A and/or 400B perform configuration in such a manner that the bands A to N come into the active state at temporally different timings (step S55). Note that although only one band is in the active state in the example of FIG. 12, two or more bands may be in the active state.

Thereafter, the base station apparatus 400A and/or 400B transmits information on the C-DRX operation configured in steps S50 to S55 to the terminal apparatus 500 (step S56). Note that the processing operations of steps S50 and S51, the processing operations of steps S52 and S53, and the processing operations of steps S54 and S55 may be performed in an order different from that in FIG. 13 or may be performed in parallel.

According to the present embodiment, in the 5G SA communication using carrier aggregation, it is possible to reduce a delay amount by dispersing the active period for each band for the communication (eMBB+URLLC) that requires implementation of both ultra-high capacity and ultra-low latency. Furthermore, according to the example of FIG. 12, all the bands are periodically activated during the C-DRX operation, and thus it is possible to maintain a state in which all the bands are always synchronized. Accordingly, in a case that communication occurs at any timing, it is possible to perform large-capacity communication using all the bands immediately.

In communication (eMBB) that requires large-capacity communication, the active period is made to be the same timing in each band. In communication (URLLC) that requires ultra-low latency, one of the bands is activated. Accordingly, it is possible to reduce latency while reducing power consumption during the C-DRX operation.

### Fourth Embodiment

Subsequently, a communication apparatus and a terminal apparatus according to a fourth embodiment of the disclosure will be described. The present embodiment relates to a specific example of an operation of a base station apparatus and a terminal apparatus in the 5G network having the SA configuration described in the third embodiment. Only different points from the second embodiment will be described below.

As described above, configuration of the NR base station apparatuses 400A and 400B according to the present embodiment is the same as in FIG. 6B described in the second embodiment. However, DRX configuration data 620 held by the DRX configuration storage unit 434 according to the present embodiment is data for implementing the C-DRX operation as illustrated in FIG. 12. Based on the DRX configuration data 620, the DRX configuration processing unit 432 configures the C-DRX operation of the terminal apparatus 500.

That is, each of the base station apparatuses 400A and 400B includes a control unit (for example, particularly the DRX configuration processing unit 432) 430 that determines a configuration value related to the DRX operation in the terminal apparatus 500 that can perform wireless communication by the NR scheme using carrier aggregation including a first carrier component (for example, band A) and a second carrier component (for example, band B), and a transmission unit 420 that transmits the configuration value determined by the control unit 430 to the terminal apparatus 500. In a case that the terminal apparatus is in a first state, for example, for eMBB+URLLC, the control unit 430 determines the configuration value to be a first value in such a manner that the first carrier component and the second carrier component come into the active state in a predetermined cycle and come into the active state at temporally different timings, with regard to the DRX operation. On the other hand, in a case that the terminal apparatus is in a second state, for example, for eMBB, the control unit 430 determines the configuration value to be a second value different from the first value in such a manner that the first carrier component and the second carrier component come into the active state in a predetermined cycle and temporally in parallel, with regard to the DRX operation.

The configuration of the terminal apparatus 500 according to the present embodiment is also substantially the same as that in FIG. 7 described in the second embodiment and is obtained by eliminating the first transmission and/or reception unit 521. That is, the terminal apparatus 500 includes a communication unit 520 that can perform wireless communication by the New Radio (NR) scheme using carrier aggregation including a first carrier component (for example, band A) and a second carrier component (for example, band B), and a control unit 530 (for example, particularly a DRX configuration unit 532) that performs a DRX operation in a first mode, for example, for eMBB+URLLC, and a second mode, for example, for eMBB. Then, in the first mode, for example, in a case of the terminal apparatus for eMBB+URLLC, the control unit 530 brings the first carrier component and the second carrier component into the active state in a predetermined cycle and at temporally different timings, with regard to the DRX operation. On the other hand, in the second mode, for example, in a case of the terminal apparatus for eMBB, the control unit 530 brings the first carrier component and the second carrier component into the active state in a predetermined cycle and temporally in parallel, with regard to the DRX operation.

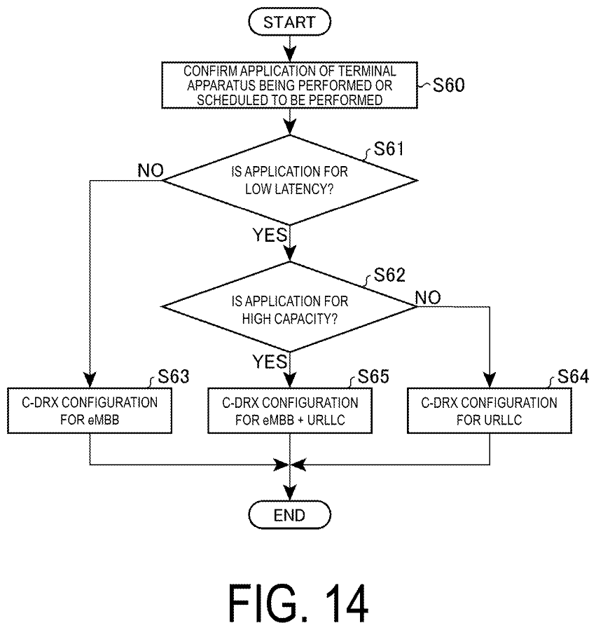

FIG. 14 is a flowchart illustrating an example of a configuration method of the C-DRX operation. In the present example, the configuration of the C-DRX operation can be changed based on a communication application of the terminal apparatus 500.

As illustrated, for example, the DRX configuration processing unit 432 of each of the NR base station apparatuses 400A and 400B confirms a communication application that is being performed or is scheduled to be performed by the terminal apparatus 500 (step S60). This corresponds to step S23 described in FIG. 8 of the second embodiment. Then, in a case that the communication application being performed or scheduled to be performed by the terminal apparatus 500 is not for low latency (NO in step S61), that is, in a case that the terminal apparatus 500 is in the second state described above, the DRX configuration processing unit 432 selects the C-DRX configuration for ultra-high capacity (step S63). That is, the C-DRX configuration for eMBB described with reference to FIG. 12 is selected, and the corresponding DRX configuration data is transmitted to the terminal apparatus 500.

In a case that the communication application being performed or scheduled to be performed by the terminal apparatus 500 is for low latency (YES in step S61) and for large capacity (YES in step S62), that is, in a case that the terminal apparatus 500 is in the first state described above, the DRX configuration processing unit 432 selects the C-DRX configuration for ultra-high capacity and ultra-low latency (step S65). That is, the C-DRX configuration for eMBB+URLLC described in FIG. 12 is selected, and the DRX configuration data corresponding to this is transmitted to the terminal apparatus 500.

Furthermore, in a case that the communication application being performed or scheduled to be performed by the terminal apparatus 500 is for low latency (YES in step S61) and is not for large capacity (NO in step S62), the DRX configuration processing unit 432 selects, for example, the C-DRX configuration for ultra-low latency (step S64). That is, the C-DRX configuration for URLLC described with reference to FIG. 12 is selected, and the DRX configuration data corresponding to this is transmitted to the terminal apparatus 500.

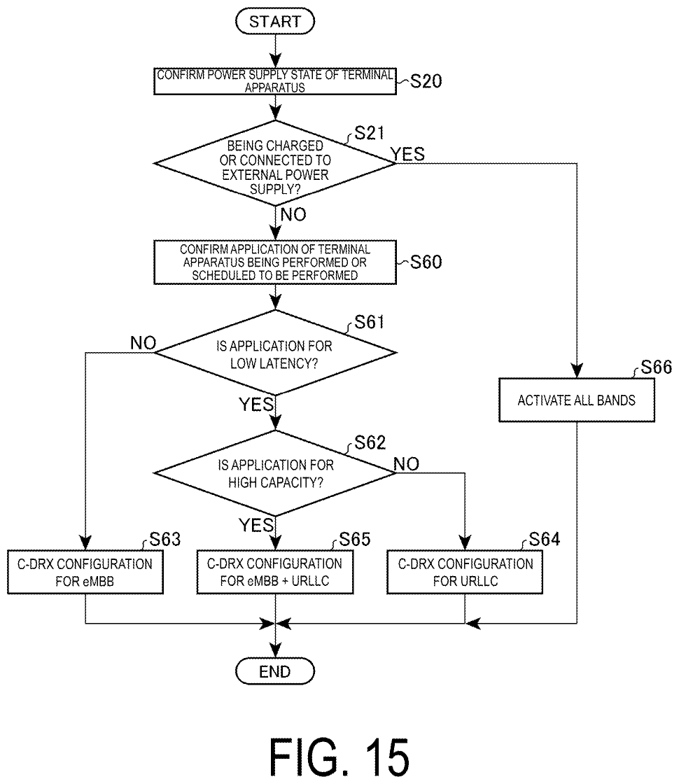

Note that also in the present embodiment, a type and a power supply connection state of the terminal apparatus 500 may be taken into consideration as in the case in FIG. 8 described in the second embodiment. FIG. 15 is a flowchart illustrating a configuration method of the C-DRX operation in this case. As illustrated, in a case that it is determined in step S20 that the terminal apparatus 500 is being charged or is connected to an external power supply (YES in step S21), the NR base station apparatuses 400A and 400B always bring all bands (or a plurality of bands) into the active state (step S66).

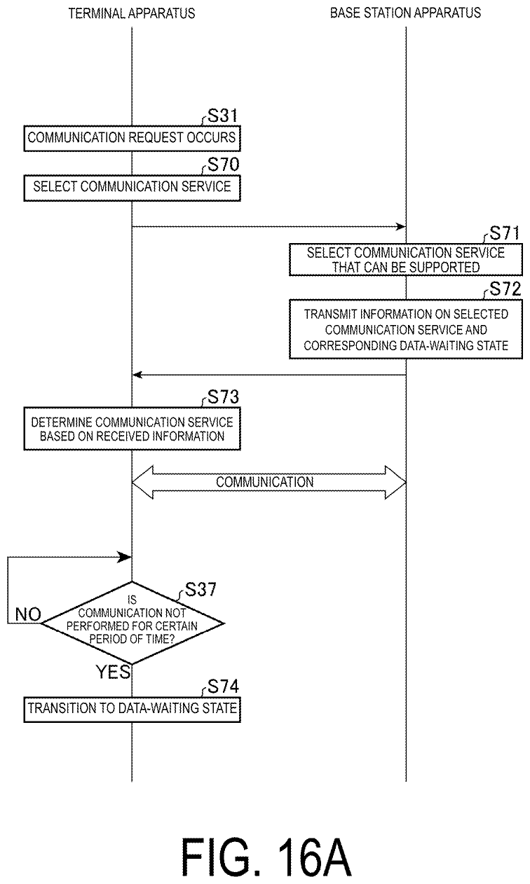

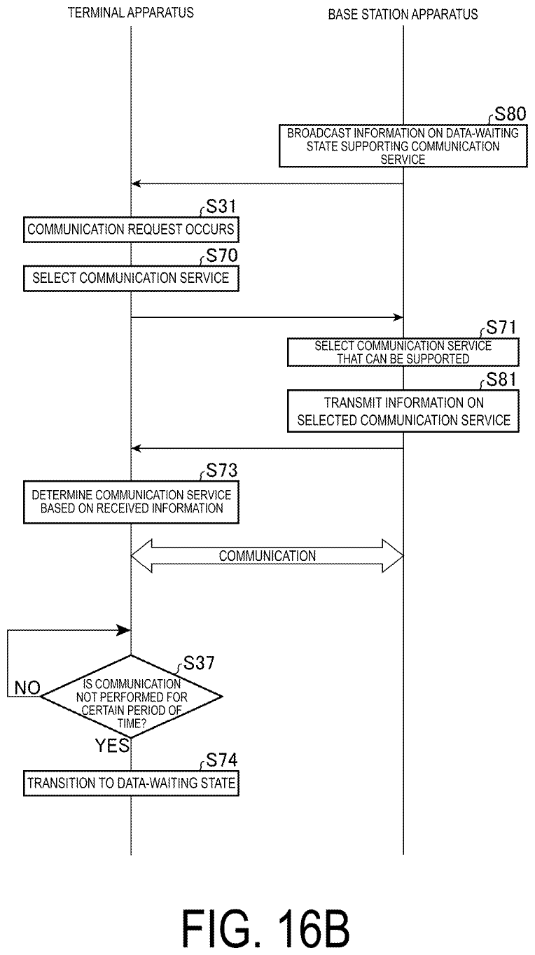

Note that C-DRX configuration depending on a communication service in steps S60 to S65 in FIG. 14 and FIG. 15 may be performed in response to a request from the terminal apparatus 500 as in the second embodiment. Such an example will be described with reference to FIG. 16A. FIG. 16A is a flowchart illustrating a flow of processing of the terminal apparatus 500 and the NR base station apparatuses 400A and 400B and corresponds to FIG. 9A described in the second embodiment. Hereinafter, only points different from the example in FIG. 9A will be described.

As illustrated, in a case that a communication request occurs in the terminal apparatus 500 (step S31), the terminal apparatus 500 selects a communication service (eMBB, URLLC, or the like) (step S70) and transmits information on the selected communication service to the base station apparatuses 400A and 400B. As in the second embodiment, in the information transmitted here, not only the type of the communication service but also information on the active period, the inactive period, and/or the shift of the active period at the time of the C-DRX operation requested by the terminal apparatus may be included, or a plurality of communication services may be included together with a priority order.

The base station apparatuses 400A and 400B determine whether they can support the request from the terminal apparatus 500. Then, the base station apparatuses 400A and 400B select a communication service that can be supported (step S71) and transmit the selected communication service and information on the data-waiting state (DRX configuration data) corresponding to the selected communication service to the terminal apparatus 500 (step S72). In response to this, the terminal apparatus 500 determines a communication service (step S73) and communicates with the base station apparatuses 400A and 400B using the communication service.

Thereafter, in a case that communication is stopped for a certain period of time (YES in step S37), the terminal apparatus 500 transitions to a data-waiting state (step S74). At this time, the terminal apparatus 500 transitions to the data-waiting state based on the information on the data-waiting state received in step S72. That is, for example, the C-DRX operation is performed using the configuration for eMBB, the configuration for URLLC, or the configuration for eMBB+URLLC described with reference to FIG. 12.

Note that similarly to the example of FIG. 9B described in the first embodiment, in FIG. 16A, the base station apparatuses 400A and 400B may notify the terminal apparatus 500 of the data-waiting state corresponding to the communication service in advance. A flowchart in such a case is illustrated in FIG. 16B. As illustrated, the base station apparatuses 400A and 400B notify the terminal apparatus 500 of information on data-waiting state corresponding to the communication service by broadcast information (step S80). Specifically, the information on the C-DRX configuration described with reference to FIG. 12 of the third embodiment is broadcast to the terminal apparatus 500. Then, in a case that the base station apparatuses 400A and 400B transmit the information on the communication service selected in step S71 to the terminal apparatus 500 (step S81), the terminal apparatus 500 performs various types of configuration based on the information received in step S80 in a case that the C-DRX operation is initiated in step S74.

As described above, in the communication system according to the present embodiment, it is possible to perform appropriate C-DRX configuration corresponding to a service with which communication is performed between the terminal apparatus 500 and the base station apparatuses 400A and 400B.

### Fifth Embodiment

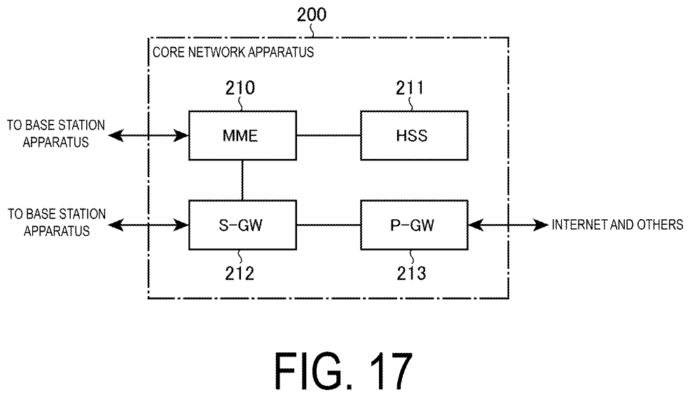

Subsequently, a communication apparatus and a terminal apparatus according to a fifth embodiment of the disclosure will be described. The present embodiment relates to an example in which the configuration related to the C-DRX operation described in the first and second embodiments is performed not by the base station apparatus but by the core network apparatus. Only different points from the first and second embodiments will be described below. FIG. 17 is a block diagram of a core network apparatus 200 according to the present embodiment.

As illustrated, the core network apparatus 200 includes a Mobility Management Entity (MME) 210, a Home Subscriber Server (HSS) 211, a Serving Gateway (S-GW) 212, and a Packet data network Gateway (P-GW) 213.

The MME 210 mainly performs mobility management of the terminal apparatus 500. The mobility management function includes network registration (attachment), calling (paging) of the terminal apparatus 500, and handover control. The HSS 211 is a database in which subscriber information is stored, receives subscriber information transmitted from the terminal apparatus 500 at the time of attachment, and confirms whether connection is from a valid subscriber terminal. The S-GW 212 is connected to a plurality of base station apparatuses (in the present example, for example, base station apparatuses 300 and 400). Then, in handover in a case that the terminal apparatus 500 moves, the S-GW 212 performs processing for switching the base station apparatuses. The P-GW 213 is connected to an external network such as the Internet and controls transmission and/or reception of data transmitted and/or received by the terminal apparatus 500 between the external network and the terminal apparatus 500.

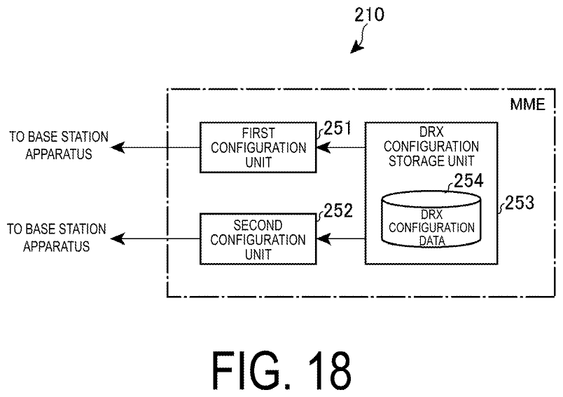

The MME 210 according to the present embodiment performs the processing operations related to the DRX configuration described in the first and second embodiments. FIG. 18 is a block diagram of the MME 210 according to the present embodiment and particularly illustrates only a portion related to control of the C-DRX operation. Note that in the present embodiment, a case where the MME 210 controls the C-DRX operation will be described as an example. However, any unit in the core network apparatus 200 may perform the control.

As illustrated, the MME 210 includes a first configuration unit 251, a second configuration unit 252, and a DRX configuration storage unit 253. Each of the first configuration unit 251 and the second configuration unit 252 may be a processor such as a CPU, for example, and the DRX configuration storage unit 253 may be a storage apparatus such as a flash memory, a ROM, or a RAM, for example. The DRX configuration storage unit 253 holds DRX configuration data 254. The DRX configuration data 254 corresponds to pieces of the DRX configuration data 610 and 620 described in the first and second embodiments and is data for performing the operation described with reference to FIG. 2, and a specific example thereof is as described with reference to FIG. 3. The first configuration unit 251 determines DRX configuration for the terminal apparatus 500 for eMBB and transmits the determined DRX configuration to the base station apparatuses 300 and 400. The second configuration unit 252 determines DRX configuration for the terminal apparatus 500 for URLLC and transmits the determined DRX configuration to the base station apparatuses 300 and 400. That is, the first configuration unit 251 and the second configuration unit 252 perform, for example, the processing of FIG. 4 described in the first embodiment.

That is, the MME 210 (in other words, the core network apparatus 200) according to the present embodiment includes control units 251 and 252 that configure configuration values related to discontinuous reception (DRX) operations in a first terminal apparatus 500, for example, the terminal apparatus 500 for URLLC, and a second terminal apparatus 500, for example, the terminal apparatus for eMBB, that can perform wireless communication by both the first communication scheme NR and the second communication scheme LTE, and transmission units 251 and 252 that transmit the configured configuration values to the base station apparatuses 300 and 400. Then, with regard to the DRX operation of the first terminal apparatus, for example, the terminal apparatus 500 for URLLC, the control units configure the configuration values for the first communication scheme NR and the second communication scheme LTE in such a manner that the first communication scheme NR and the second communication scheme LTE come into the active state in a predetermined cycle and at temporally different timings, for example. On the other hand, with regard to the DRX operation of the second terminal apparatus, for example, the terminal apparatus for eMBB, the control units configure the configuration values for the first communication scheme NR and the second communication scheme LTE in such a manner that the first communication scheme NR and the second communication scheme LTE come into the active state in a predetermined cycle and temporally in parallel, for example.

Then, the base station apparatuses 300 and 400 according to the present embodiment receive the DRX configuration data 254 from the core network apparatus 200 and hold the received data as the DRX configuration data 610 and 620. Then, based on the DRX configuration data 610 and 620, the DRX operations of the terminal apparatus for eMBB and the terminal apparatus for URLLC are configured. That is, for example, in FIG. 9B described in the second embodiment, in step S40, each of the base station apparatuses 300 and 400 transmits the configuration value related to the DRX operation determined by the core network apparatus 200 to the terminal apparatus 500. Then, in step S36, the terminal apparatus 500 configures the DRX operation based on the received configuration value.

As described above, the C-DRX configuration operation described in the first and second embodiments may be performed by the core network apparatus instead of the base station apparatus.

### Sixth Embodiment

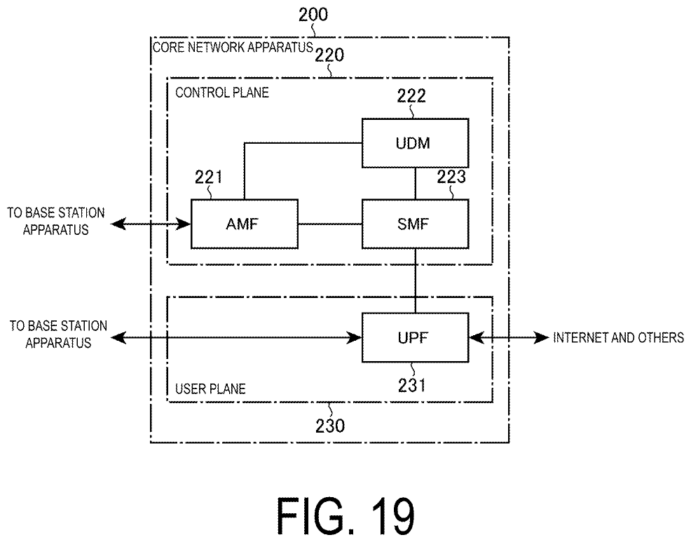

Subsequently, a communication apparatus and a terminal apparatus according to a sixth embodiment of the disclosure will be described. The present embodiment relates to an example in which the configuration related to the C-DRX operation described in the third and fourth embodiments is performed not by the base station apparatus but by the core network apparatus as in the fifth embodiment. Only different points from the first and second embodiments will be described below. FIG. 19 is a block diagram of a core network apparatus 200 according to the present embodiment.

As illustrated, the core network apparatus 200 according to the present embodiment roughly includes a control plane 220 and a user plane 230. The control plane 220 performs connection and mobility management of the terminal apparatus 500, and the user plane 230 processes user data transmitted and/or received by the terminal apparatus 500. The user plane 230 includes a User Plane Function (UPF) 231, and the UPF 231 implements functions corresponding to user plane 230 portions of both the S-GW 212 and the P-GW 213 described with reference to FIG. 17 of the fifth embodiment. That is, the UPF 231 is connected to the NR base station apparatuses 400A and 400B and an external network and controls transmission and/or reception of data transmitted and/or received by the terminal apparatus 500 between the terminal apparatus 500 and the external network.

The control plane 220 includes an Access and Mobility Management Function (AMF) 221, a Unified Data Management (UDM) 222, and a Session Management Function (SMF) 223. The AMF 221 performs mobility management of the terminal apparatus 500. For example, the AMF 221 according to the present embodiment performs processing related to DRX configuration. In other words, the AMF 221 implements the function of the MME 210 in the EPC described in the fifth embodiment. The SMF 223 has functions corresponding to control plane portions of both the S-GW 212 and the P-GW 213 and performs, for example, session management. The UDM 222 also manages subscriber information.

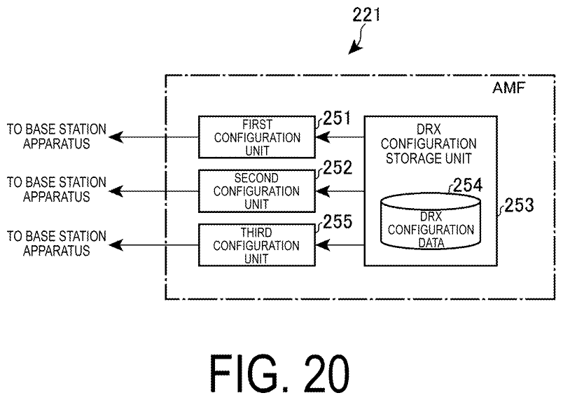

FIG. 20 is a block diagram of the AMF 221 according to the present embodiment and particularly illustrates only a portion related to control of the C-DRX operation. Note that in the present embodiment, a case where the AMF 221 controls the C-DRX operation will be described as an example. However, any unit in the core network apparatus 200 may perform the control.

As illustrated, the AMF 221 further includes a third configuration unit 255 in the configuration of the MME 210 described with reference to FIG. 18 in the fifth embodiment. The third configuration unit 255 determines the DRX configuration of the terminal apparatus for ultra-high capacity and ultra-low latency (eMBB+URLLC) described in the third embodiment. The other configuration is as described in the fifth embodiment. That is, the first to third configuration units 251, 252, and 255 perform, for example, the processing of FIG. 13 described in the third embodiment.

That is, the AMF 221 (in other words, the core network 200) according to the present embodiment includes the control units that configure configuration values related to DRX operations in a first terminal apparatus, for example, a terminal apparatus for eMBB+URLLC and a second terminal apparatus, for example, a terminal apparatus for eMBB, that can perform wireless communication by the New Radio (NR) scheme using carrier aggregation including a first carrier component (band A described below) and a second carrier component (band B described below), and transmission units that transmit the configuration values configured by the control units to the base station apparatuses 400A and 400B. Then, with regard to the DRX operation of the first terminal apparatus, for example, the terminal apparatus for eMBB+URLLC, the control units configure the configuration values in such a manner that the first carrier component and the second carrier component come into the active state in a predetermined cycle and at temporally different timings. On the other hand, with regard to the DRX operation of the second terminal apparatus, for example, the terminal apparatus for eMBB, the control units configure the configuration values in such a manner that the first carrier component and the second carrier component come into the active state in a predetermined cycle and temporally in parallel.

Then, the base station apparatuses 400A and 400B according to the present embodiment receive the DRX configuration data 254 from the core network apparatus 200 and hold the received data as the DRX configuration data 620. Then, based on the DRX configuration data 620, the DRX operation of the terminal apparatus for eMBB, the terminal apparatus for URLLC, and the terminal apparatus for eMBB+URLLC are configured. That is, for example, in FIG. 16B described in the fourth embodiment, in step S80, each of the base station apparatuses 400A and 400B transmits the configuration value related to the DRX operation determined by the core network apparatus 200 to the terminal apparatus 500. Then, in step S73, the terminal apparatus 500 configures the DRX operation based on the received configuration value.

As described above, the C-DRX configuration operation described in the third and fourth embodiments may be performed by the core network apparatus instead of the base station apparatus.

### Modification and Others

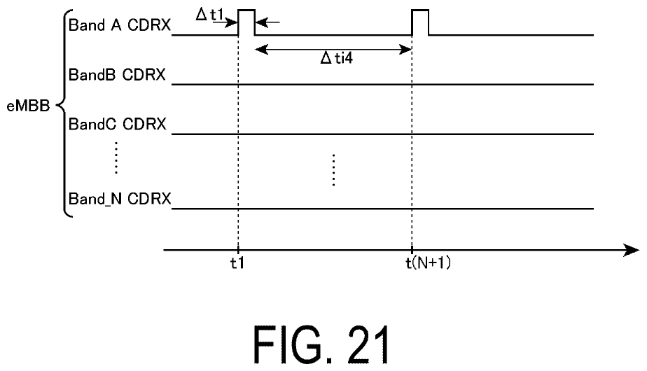

Note that the configuration and operations of the core network apparatus 200, the base station apparatuses 300, 400A, and 400B, and the terminal apparatus 500 described in the above embodiments are merely examples, and various modifications are possible. For example, regarding the DRX configuration described with reference to FIG. 12, for example, the DRX configuration described as for URLLC may be used as for mMTC. In a case that ultra-low latency is not required and ultra-high capacity is required, the DRX configuration that has been indicated as the configuration for eMBB in FIG. 12 may be performed, but for example, as illustrated in FIG. 21, the DRX operation may be performed in any one band and the other bands may always be in the inactive state. Note that in the example of FIG. 21, the DRX operation may be performed in two or more and less than N bands. In addition, in the above embodiments, as the type of the terminal apparatus, the terminal apparatus for eMBB, the terminal apparatus for URLLC, the terminal apparatus for mMTC, and the terminal apparatus for eMBB+URLLC have been described as examples, but the type is not limited thereto, and the DRX configuration may be performed depending on various requests of the terminal apparatus.

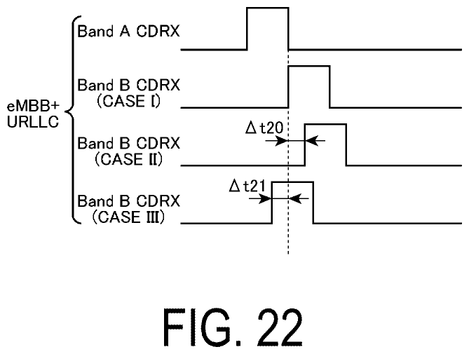

Note that the C-DRX operation illustrated for eMBB+URLLC in FIG. 12 is not necessarily limited to the case where another band becomes active at the timing at which a certain band becomes inactive. Such an example is illustrated in FIG. 22. FIG. 22 illustrates a timing at which the band B comes into the active state next to the band A.

In CASE I of FIG. 22, the band A becomes inactive and at the same time, the band B becomes active. However, as illustrated in CASE II, the band B may become active after a period Δt20 (>0) elapses from the time point at which the band A becomes inactive, or as illustrated in CASE III, the band B may become active at a time point that is Δt21 (>0) before the time point at which the band A becomes inactive.

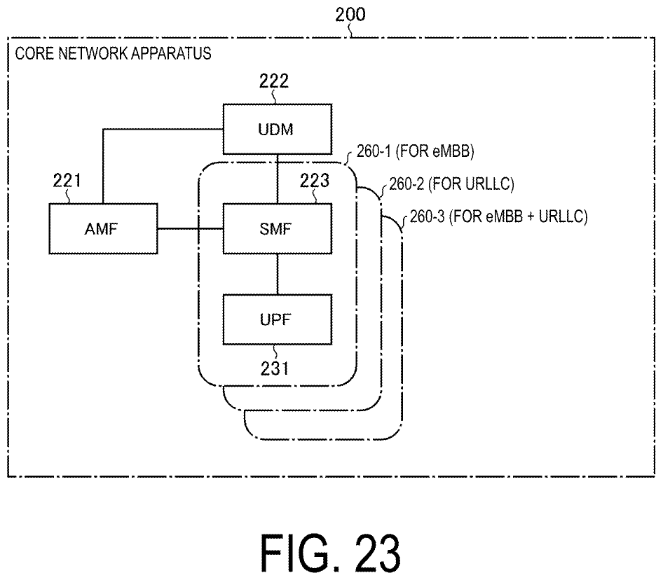

A network slicing technique may also be used in the 5G core network. This is illustrated in FIG. 23. FIG. 23 is a conceptual diagram of a 5G core network apparatus 200. In network slicing, a virtualization technique of network functions is used to configure a plurality of logical divisions on a common hardware resource, thereby separating the network functions for management and operation. For example, as illustrated in FIG. 23, the SMF 223 and the UPF 231 in the core network apparatus 200 are virtually separated logically into a plurality of blocks. Then, for example, a virtual block 260-1 is used for eMBB, a block 260-2 is used for URLLC, and a block 260-3 is used for eMBB+URLLC. That is, the core network apparatus 200 may include a slice for URLLC, a slice for eMBB, and a slice for eMBB+URLLC by the network slicing technique. As described above, it is possible to improve the resource utilization efficiency of the entire core network apparatus 200 by using the network slicing technique.

In the network slicing technique as described above, the information on the data-waiting state (the configuration value of the C-DRX operation described with reference to FIG. 2 and FIG. 3) may be transmitted from the base station apparatus 400 to the terminal apparatus 500 together with information on the slice to be used by the terminal apparatus 500. That is, for example, the “communication services” in FIG. 16A and FIG. 16B can correspond to the slices 260-1 to 260-3 in FIG. 23. Accordingly, for example, in step S70, the terminal apparatus 500 may select any one of the slices 260-1 to 260-3 and transmit a request for the selected slice to the base station apparatus 400. For example, in a case that the terminal apparatus 500 is for eMBB+URLLC, the terminal apparatus 500 selects and requests the slice 260-3. This request is transmitted from the base station apparatus 400 to, for example, the AMF 221 of the core network apparatus 200, and the AMF 221 determines whether the request is acceptable. Then, in step S72, based on the determination result in the AMF 221, information on the slice corresponding to the terminal apparatus 500 is transmitted to the terminal apparatus 500. For example, in a case that the request by the terminal apparatus 500 is accepted, for example, the terminal apparatus 500 is notified of the slice number of the slice 260-3 for eMBB+URLLC (for example, Network Slice Selection Assistance information (NSSAI)). At this time, the configuration value of the C-DRX operation described above may be transmitted to the terminal apparatus 500 together with the slice number. That is, in a case that a network slice is requested from the terminal apparatus in, for example, a registration request or the like, the base station apparatus (or the core network apparatus) may transmit a signal in which the C-DRX configuration value (this configuration value can be said to be a configuration value corresponding to the selected slice) is included in information on the selected network slice to the terminal apparatus as a response thereto. Note that the number of slices allocated to one terminal apparatus is not limited to one and may be plural.

Although some embodiments of the disclosure have been described above, the disclosure is not limited to the above-described embodiments and can be appropriately modified. Each configuration described above can be replaced with substantially the same configuration, a configuration that has the same effects, or a configuration that can achieve the same object.

1. A communication apparatus comprising:
a control unit configured to configure a configuration value related to a discontinuous reception (DRX) operation in a terminal apparatus depending on a state of the terminal apparatus configured to perform wireless communication by both a first communication scheme and a second communication scheme; and
a transmission unit configured to transmit the configuration value configured by the control unit to a base station apparatus or the terminal apparatus,
wherein the control unit
configures, in a case that the terminal apparatus is in a first state, the configuration value to a first value for the first communication scheme and the second communication scheme in such a manner that the first communication scheme and the second communication scheme come into an active state at temporally different timings, with regard to the DRX operation.

2. The communication apparatus according to claim 1,
wherein in a case that the terminal apparatus is in a second state different from the first state, the control unit configures the configuration value to a second value different from the first value for the first communication scheme and the second communication scheme in such a manner that the first communication scheme and the second communication scheme come into an active state temporally in parallel, with regard to the DRX operation.

3. The communication apparatus according to claim 2, further comprising
a reception unit configured to receive information on a state of the terminal apparatus from the terminal apparatus,
wherein the first state is a state where the terminal apparatus is performing or is scheduled to perform an application for Ultra-Reliable and Low Latency Communication (URLLC), and
wherein the second state is a state where the terminal apparatus is performing or is scheduled to perform an application for enhanced Mobile Broadband (eMBB).

4. The communication apparatus according to claim 1,
wherein in a case that the terminal apparatus is connected to a power supply, the control unit commands the terminal apparatus to be always in an active state without performing the DRX operation.

5. The communication apparatus according to claim 1,
wherein in a case that the configuration value is configured to the first value, the terminal apparatus is deactivated for the second communication scheme during a period where the terminal apparatus is activated for the first communication scheme and is also deactivated for the first communication scheme during a period in which the terminal apparatus is activated for the second communication scheme.

6. The communication apparatus according to claim 1,
wherein the first communication scheme is New Radio (NR), and the second communication scheme is Long Term Evolution (LTE).

7. A terminal apparatus comprising:
a first communication unit configured to perform wireless communication by a first communication scheme;
a second communication unit configured to perform wireless communication by a second communication scheme; and
a control unit configured to perform a discontinuous reception (DRX) operation in a first mode,
wherein the control unit
brings the first communication unit and the second communication unit into an active state at temporally different timings in the first mode, with regard to the DRX operation.

8. The terminal apparatus according to claim 7,
wherein the control unit is further configured to perform the DRX operation in a second mode different from the first mode, and the control unit
brings the first communication unit and the second communication unit into an active state temporally in parallel in the second mode, with regard to the DRX operation.

9. The terminal apparatus according to claim 8,
wherein the first communication unit and/or the second communication unit receives information on whether to operate in the first mode or the second mode with regard to the DRX operation, from a base station apparatus.

10. The terminal apparatus according to claim 8,
wherein the first communication unit and/or the second communication unit is configured to transmit information on whether the terminal apparatus is in a first state or a second state to a base station apparatus,
wherein the first state is a state where the terminal apparatus is performing or is scheduled to perform an application for Ultra-Reliable and Low Latency Communication (URLLC), and
wherein the second state is a state where the terminal apparatus is performing or is scheduled to perform an application for enhanced Mobile Broadband (eMMB).

11. The terminal apparatus according to claim 10,
wherein in a case that the first communication unit and/or the second communication unit transmits information indicating that the terminal apparatus is in the first state to the base station apparatus, the first communication unit and/or the second communication unit receives information indicating that the terminal apparatus operates in the first mode from the base station apparatus, and
wherein in a case that the first communication unit and/or the second communication unit transmits information indicating that the terminal apparatus is in the second state to the base station apparatus, the first communication unit and/or the second communication unit receives information indicating that the terminal apparatus operates in the second mode from the base station apparatus.

12. The terminal apparatus according to claim 10,
wherein the first communication unit and/or the second communication unit receives information indicating that the base station apparatus is configured to support the first state and the second state, together with broadcast information.

13. The terminal apparatus according to claim 7,
wherein the first communication unit and/or the second communication unit is configured to transmit information indicating that the terminal apparatus is in a state of being connected to a power supply to a base station apparatus, and
wherein in a case that the information is transmitted, the first communication unit and/or the second communication unit receives a command from the base station apparatus in such a manner that the first communication unit and/or the second communication unit is always in an active state without performing the DRX operation.

14. The terminal apparatus according to claim 7,
wherein the first communication scheme is New Radio (NR), and the second communication scheme is Long Term Evolution (LTE).

15. A communication apparatus comprising:
a control unit configured to configure a configuration value related to a discontinuous reception (DRX) operation in a terminal apparatus configured to perform wireless communication by a new radio (NR) scheme using carrier aggregation including a first carrier component and a second carrier component; and
a transmission unit configured to transmit the configuration value configured by the control unit to a base station apparatus or the terminal apparatus,
wherein the control unit
configures, in a case that the terminal apparatus is in a first state, the configuration value to a first value in such a manner that the first carrier component and the second carrier component come into an active state at temporally different timings from each other, with regard to the DRX operation.

16. The communication apparatus according to claim 15,
wherein in a case that the terminal apparatus is in a second state different from the first state, the control unit configures the configuration value to a second value different from the first value in such a manner that the first carrier component and the second carrier component come into an active state temporally in parallel, with regard to the DRX operation.

17. The communication apparatus according to claim 16, further comprising
a reception unit configured to receive information on a state of the terminal apparatus from the terminal apparatus,
wherein the first state is a state where the terminal apparatus is performing or is scheduled to perform an application for Ultra-Reliable and Low Latency Communication (URLLC) and enhanced Mobile Broadband (eMBB), and
wherein the second state is a state where the terminal apparatus is performing or is scheduled to perform an application for eMBB.

18. The communication apparatus according to claim 15,
wherein in a case that the terminal apparatus is in the first state, the control unit configures the first value in such a manner that the terminal apparatus brings the second carrier component into an active state at a timing when the first carrier component transitions from an active state to an inactive state, with regard to the DRX operation.

19. The communication apparatus according to claim 2,
wherein the transmission unit transmits information indicating that the communication apparatus is configured to support the first state and the second state, together with broadcast information to the terminal apparatus.

20. The communication apparatus according to claim 1,
wherein the transmission unit transmits the configuration value to the base station apparatus, and
wherein the communication apparatus is a core network apparatus.

21. The communication apparatus according to claim 1,
wherein the transmission unit transmits the configuration value to the terminal apparatus, and
wherein the communication apparatus is a base station apparatus.

22. A terminal apparatus comprising:
a communication unit configured to perform wireless communication by a new radio (NR) scheme using carrier aggregation including a first carrier component and a second carrier component; and
a control unit configured to perform a discontinuous reception (DRX) operation in a first mode,
wherein the control unit
brings the first carrier component and the second carrier component into an active state at temporally different timings from each other in the first mode, with regard to the DRX operation.

23. The terminal apparatus according to claim 22,
wherein the control unit is further configured to perform the DRX operation in a second mode different from the first mode, and
wherein, in the second mode, the control unit brings the first carrier component and the second carrier component into an active state temporally in parallel, with regard to the DRX operation.

24. The terminal apparatus according to claim 23,
wherein the communication unit receives information on whether to operate in the first mode or the second mode with regard to the DRX operation, from a base station apparatus.

25. The terminal apparatus according to claim 23,
wherein the communication unit is configured to transmit information on whether the terminal apparatus is in a first state or a second state to a base station apparatus, and
wherein the first state is a state where the terminal apparatus is performing or is scheduled to perform an application for Ultra-Reliable and Low Latency Communication (URLLC) and enhanced Mobile Broadband (eMBB), and
wherein the second state is a state where the terminal apparatus is performing or is scheduled to perform an application for eMMB.

26. The terminal apparatus according to claim 25,
wherein in a case that the communication unit transmits information indicating that the terminal apparatus is in the first state to the base station apparatus, the communication unit receives information indicating that the terminal apparatus operates in the first mode from the base station apparatus, and
wherein in a case that the communication unit transmits information indicating that the terminal apparatus is in the second state to the base station apparatus, the communication unit receives information indicating that the terminal apparatus operates in the second mode from the base station apparatus.

27. The terminal apparatus according to claim 26,
wherein the communication unit receives information indicating that the base station apparatus is configured to support the first state and the second state, together with broadcast information.
